(19) United States
(12) Patent Application Publication
(10) Pub. No.: US 2021/0275911 A1
(43) Pub. Date: Sep. 9, 2021

(54) METHOD AND SYSTEM FOR SCENARIO SELECTION AND MEASUREMENT OF USER ATTRIBUTES AND DECISION MAKING IN A DYNAMIC AND CONTEXTUAL GAMIFIED SIMULATION

(71) Applicant: CYMORG, INC., New York, NY (US)

(72) Inventors: Sriram Padmanabhan, New York, NY (US); Aarti Shyamsunder, NAVI MUMBAI (IN)

(21) Appl. No.: 17/225,164

(22) Filed: Apr. 8, 2021

Related U.S. Application Data
(63) Continuation-in-part of application No. 16/436,837, filed on Jun. 10, 2019.
(60) Provisional application No. 62/683,366, filed on Jun. 11, 2018.

(51) Int. Cl. A63F 13/30; A63F 13/56; A63F 13/46; A63F 13/69; G06F 40/30; G06F 40/289; G06F 16/35; G06F 16/335; G06K 9/62

(52) U.S. Cl. CPC A63F 13/30; A63F 13/56; A63F 13/46; A63F 13/69; G06K 9/6215; G06F 40/289; G06F 16/35; G06F 16/335; G06F 40/30

(57) ABSTRACT

A computer implemented method of determining the cultural style of a participant of an organization by accessing records of organizational data and participant data to generate an instance of simulation, and initiating a game simulation session. It includes receiving inputs from the participant to automatically calculate and generate a first set of simulation events, and presents to the participant a first set of events, and receives a response as textual or spoken inputs in an unstructured form. It further performs text analytics on the inputs, identifies themes and clusters based on frequency and meaning of inputs, and calculates probabilities and generates a further set of simulation events for a changed state of organizational model. It further includes presenting a further set of simulation events to the participant for inputs. These method steps are iterated until a state marker is reached. The semantic relationships are then analyzed and reports generated on culture styles.

### CROSS REFERENCE TO RELATED APPLICATIONS

This continuation-in-part application claims priority to non-provisional U.S. application Ser. No. 16/436,837, filed Jun. 10, 2019, which claims priority to U.S. provisional application Ser. No. 62/683,366, filed Jun. 11, 2018, both entitled “A Method and System for Scenario Selection and Measurement of User Attributes and Decision Making in a Dynamic and Contextual Gamified Simulation,” which applications are incorporated herein in their entirety by reference.

### BACKGROUND OF THE INVENTION

The inventive concepts relate to education and training and particularly, relate to management development. More particularly, it relates to industrial-organizational psychology/work psychology, data science, and online games and simulations.

Decision making, especially in the context of senior management roles is complex and unstructured. It takes place in an environment characterized by conflicting goals, constant context switching between competing priorities, processing of multiple concurrent risks and opportunities, many stakeholders to satisfy, and the assimilation of contradictory advice from a variety of sources. Such complex roles and responsibilities are also typically discharged without much active on-the-job hand-holding or coaching. Errors made in such roles are likely to lead to bigger organizational damage than errors made in less complex positions.

Such decision making is qualitatively different from expertise in any narrow organizational function, which can be taught as skills, or acquired through experience and observation. The task of developing employees for roles demanding enterprise thinking and complexities, or of assessing employees for their potential fit for such roles, is therefore essentially different than narrower functional or skills training. To paraphrase Ericsson et al.: Given that expertise in any domain, including leadership, is difficult to assess and develop and that the challenges are complex and context specific, providing learners with contextual, realistic problems and repeated attempts to solve them would verily constitute the deliberate practice required to build expertise. See Ericsson, K. A., Prietula, M. J., & Cokely, E. T. (2007), The Making of an Expert, Harvard Business Review (available at https://hbr.org/2007/07/the-making-of-an-expert).

Academic interest has been focused on this problem since the 1950s, and there is broad consensus that gamified simulations are the optimal mechanism for assessing and developing fit for unstructured senior management roles, from a decision-making perspective. [Sydell, E., Ferrell, J., Carpenter, J., Frost, C., & Brodbeck, C. C. (2013). Simulation scoring. In M. S. Fetzer & K. A. Tuzinski (Eds.), Simulations for personnel selection (pp. 83-107). New York: Springer.] However, in practice, there have been several difficulties that organizations have encountered in implementing such a strategy. These include the following: The simulations need to be highly contextual, relevant to the job and realistic—in order for (a) any assessments based on them to be accurate, and (b) any learning to be easy to assimilate and apply, by participants. If the solution is for one-time use only, it will not be able to capture fully the way people grow over time, by iteratively trying different options and developing their instincts for appropriate responses to situations. In order to be usable multiple times without the participants ‘gaming’ the system, it is necessary for the system to be interactive, dynamic and non-deterministic. For the solution to be continuously relevant for a period of time, it is necessary for it to be easy, quick and cheap to configure, modify and reuse. For the solution to be scalable and non-disruptive for day-to-day business, it is necessary for it to be available anytime, anywhere, without the need for synchronous human observation, proctoring or intervention.

Systems and methods for gamification are described, for example, in U.S. Pat. No. 5,632,007, and U.S. Published Application Nos. 2001/0032029, 2005/0065754, 2007/0087756, 2007/0250361, 2009/0138145, 2013/0024342, 2014/0280952, 2014/0337086, 2016/0034305, and 2017/0300657.

Although most existing solutions define contextuality as the use of industry-specific jargon in the text given to the users, a true reproduction of an organizational context will comprise the following. The use of the same, or very similar, historical data as that of the organization's—financial and non-financial data pertaining to the market, investors, employees, customers, and other areas relevant for decision-making. The use of same, or very similar, goals, targets and objectives, as those against which the user has to make decisions. Simultaneous occurrence of issues and situations of different levels of urgency and strategic importance, involving different stakeholders and aspects of the business. The fact that certain outcomes of decisions can be immediately observed, while others are tougher to predict or observe, and take place over a longer duration; also, certain outcomes may depend on the circumstances at the time when the decision is taken. The fact that the future does depend on the actions taken, but not always along completely predictable lines, there is uncertainty attached to every eventuality. This combination of requirements has made it difficult to design gamified or simulation-based assessments in practice. If the simulations are to be made highly complex and contextual, they take a long time and much cost to implement. And even then, they are difficult to keep up to date. If they are off-the-shelf and affordable, they are unlikely to be contextually relevant enough for the organization and its specific context. Added to these practical concerns, are the challenges inherent in measurement in an unstructured/dynamic simulation (Handler, 2013). [Handler, C. (2013). Foreword. In M. S. Fetzer & K. A. Tuzinski (Eds.), Simulations for personnel selection (pp. v-ix). New York: Springer]

Current solutions in the field of employee/worker assessment and development cover a gamut—from psychometric tools such as personality tests, situational judgment tests or cognitive ability tests; to ‘work sample’ tools such as assessment centers, simulations and of late, gamified assessments such as virtual assessment centers, virtual role plays or job tryouts that constitute realistic job previews. Traditional psychometric methods use sparse, self-contained pieces of evidence such as responses to multiple-choice items. With advances in digital/virtual environments, every click, keystroke, or interaction in an online assessment or simulation can be mined to inform outcomes like learning, thus challenging psychometricians to extend insights into relatively underleveraged and under-explored realms of measurement.

The usual method of building an interactive simulation or assessment instrument is the decision-tree, where scenarios for a stage are decided based on the participant's responses at the previous stage. Every time an option is chosen, the next node connected to it will always get triggered. This makes the decision-tree approach to building an interactive simulation static and deterministic. A participant can, by simply following the different branches of the tree, arrive at a quick understanding of the rules of the simulation, and then be able to predict the simulation outcomes accurately and take decisions in such a way as to achieve the target results.

However, such an exercise would prepare the participant insufficiently for real life situations and tell us nothing about the competencies and behaviors the person is likely to exhibit in real-life situations, where cause-effect relationships are less straightforward to predict. Thus, a decision-tree approach does not allow for repeated use.

The decision-tree method also rapidly becomes unwieldy when planning a simulation across more than 3-4 stages. For a four-stage simulation, for example, assuming four options for response per scenario, the decision-tree approach would require the set-up of 340 decision nodes (4+16+64+256). This adds hugely to the cost and effort of building an online simulation. Sometimes, to circumvent this, a trained human observer is placed at hand to review the participants' responses and dynamically pick the test scenarios. But this again makes the solution costly and non-scalable; trained observers are in short supply and scheduling conflicts make the process disruptive and unrealistic.

It is in this overall background that the inventive concepts have been designed.

### SUMMARY OF THE INVENTION

The inventive concepts overcome the disadvantages of the prior art and fulfill the needs noted above by providing systems and methods for minimizing the need for a human observer or coach by creating a novel virtual, digital ‘sandbox’ that allows users to experiment with different decisions and approaches in a realistic, yet simulated context. To recreate a realistic experience, it leverages, inter alia, the elements of existing solutions, such as, serious games (including feedback, realism, points), simulations (including real-world data and situations), and situational judgment tests (including realistic organizational scenarios and decision making) etc. But our disclosure goes beyond these features and practices. Embodiments of the inventive concepts provide systems and methods that may include some or all of the features described below.

The important aspects for optimal assessment and subsequent personal development, especially for leaders, include the extent to which an individual can: Make and execute plans, prioritize information from numerous sources, make day-to-day strategic as well as operational decisions, work well with others, learn and grow from feedback, deal with multiple stakeholders and competing priorities, retain organizational values and objectives, and so on. Such aspects are difficult to assess utilizing simple multiple-choice or Likert type (continuous scale) response formats, common in traditional psychometric assessment approaches. The difficulty also lies in measuring these aspects by the currently available scoring and analytics approaches which don't always factor in elements such as the dynamism, idiosyncrasy, simultaneity of inputs, combination of detailed and holistic priorities and so on.

Resolving the tradeoff between (structured) measurement and dynamism within simulations, and then making reasonable inferences about people based on their wide open and unstructured interactions within complex simulated work environments of all types, therefore, is the Holy Grail for measurement in simulations. Embodiments of the inventive concepts combine the strengths of work psychology, with its high-quality measurement techniques and rich theory with those of data science, that has flexibility and analytical power.

Embodiments of the inventive concepts disclosed herein include a software system and a method for dynamically delivering an online simulation experience as well as an automated, probabilistic system and a measurement framework for scoring, analyzing and summarizing critical human attributes that may be inferred from users' behavior and choices within such an experience.

In one of the embodiments of the inventive concepts, the delivery system and method involves a computer system picking a number of scenarios to present to a user at every juncture in the online, gamified simulation (that is, during each “move”, which may be a unit of time like a month or a quarter, in the “game”, which we are using interchangeably with gamified simulation for the sake of convenience), such that the picked scenarios are the most probable ones to take place given the state of the hypothetical organizational context and given all that has taken place until that point. Briefly, the method utilizes a basic machine learning technique, the Hidden State Markovian Model Makes it easy to design or “author” a simulated work context, and easy to modify a simulation that can run for any number of ‘moves’, without humans having to create complex decision-trees. The method allows for a high degree of realism and high face validity/psychological fidelity. It is probabilistic, dynamic and non-deterministic, and so makes it nearly impossible for a user to experience the exact same configuration of scenarios or events more than once.

The resultant system is a faithful reproduction of real work life, in that decisions do result in changes in organizational data, but not all changes are predictable and observable. The extent of the changes varies depending on the circumstances under which the decisions were made. Unlike simulation-based analysis of financial models that test for capital adequacy in unfavorable economic scenarios, the present system is more comprehensive, including both financial and non-financial aspects of the enterprise. Secondly, the present system incorporates human elements of decision-making—such as adherence to organizational values, ability to identify risks and opportunities, exercising judgment, displaying preferences and choices—and not just the systemic elements. Finally, the test scenarios are not pre-programmed in a static way, but take place according to their probability, given the situation at any point. An important characteristic of this system is that there is no static script according to which the simulation unfolds. Events are not necessarily directly triggered by actions or other events. The probability of an event taking place increases or decreases according to the circumstances. In the Hidden State Markovian model, the circumstances are defined by the state of health of the organization along any number of dimensions at any time (described in the detailed description section below) However, these definitions are not available to the participant, and the rules for transitioning from one state of health to another are also hidden from them. This leads to an unscripted, dynamic experience that best reflects the incompletely predictable nature of real life challenges.

Another embodiment of the inventive concepts includes a delivery system and method for picking a number of scenarios to present to a user at every juncture in the online, gamified simulation such that the picked scenarios are the most probable ones to take place given the state of the hypothetical organizational context and given all that has taken place until that point.

Embodiments of the inventive concepts include a system and a measurement framework for scoring, analyzing and summarizing critical human attributes that may be inferred from users' behavior and choices in digital/virtual, dynamic, gamified simulations. This framework includes conceptualizing and scoring behavioral competencies as complex products of person-situation interactions, i.e. “Reimagining Competencies as Person-Situation Interactions Using a Partial Credit Model”. The method disclosed herein harnesses ‘paradata’ (i.e. clickstream, choice patterns, time taken etc.) to provide scores on decision-making processes, i.e. “Human Information Processing: Insights Using Paradata”. It uses within-simulation interpersonal behavior to create collaboration or advice-seeking indices, i.e. “Communication Indices: Insights Using Paradata”. It analyzes user-generated constructed response text-based, audio or video data, i.e. “Analytics using Natural Language Understanding, Natural Language Processing, Text Analytics etc. for Constructed Response Data”. It provides trajectories of change within and across individuals to assess growth over time, i.e. “Measuring Individual and Group Developmental Trajectories.”

Other features and advantages of the inventive concepts will become apparent from the following description of the invention, which refers to the accompanying drawings.

### BRIEF DESCRIPTION OF THE DRAWINGS

FIGS. 1A-1B illustrate the states of health and how the states are defined in accordance with an embodiment of the inventive concepts;

FIG. 2 illustrates a flowchart of the overall flow of the game, i.e., an overall simulation flow in accordance with an embodiment of the inventive concepts;

FIGS. 3A-3C depict simulation results using a method, and in particular an “Event picking logic” in accordance with an embodiment of the inventive concepts;

FIG. 4 illustrates a mixed-methods measurement at the individual and group level in accordance with an embodiment of the inventive concepts;

FIG. 5 depicts a game utilizing semantic analysis in accordance with an embodiment of the inventive concepts;

FIG. 6 illustrates the working of an entire service in accordance with an embodiment of the inventive concepts;

FIGS. 7A-7C illustrate how free text input is collected from participants and Conversational AI services is used to match a response to an appropriate pre-authored choice in accordance with an embodiment of the inventive concepts;

FIG. 8 illustrates an analytics module in accordance with an embodiment of the inventive concepts;

FIGS. 9A-9D illustrate the structure of a service in accordance with an embodiment of the inventive concepts;

FIG. 10 illustrates a bottom up analytics generated as part of the automatic game report at the end of every simulation in accordance with an embodiment of the inventive concepts;

FIG. 11A exemplarily depicts a list of all games played in a particular series in accordance with an embodiment of the inventive concepts;

FIG. 11B displays a series, filtered on games that feature sentiments semantically close to the word “change” in accordance with an embodiment of the inventive concepts; and

FIG. 12 illustrates text based cultural style diagnosis for a group of mid-level managers in an R&D center of a semi-conductor manufacturing organization in accordance with an embodiment of the inventive concepts.

### DETAILED DESCRIPTION OF THE PREFERRED EMBODIMENTS

Disclosed embodiments relate to systems and methods for organizational decision-making.

The terminology used herein is for the purpose of describing particular embodiments only and is not intended to limit the invention. As used herein, the singular terms “a,” “an,” and “the” are intended to include the plural forms as well, unless the context clearly indicates otherwise.

Glossary of terms as a “dictionary” as used herein or commonly understood in the literature is provided below.

“Assessment”: A test or a method of systematically gathering, analyzing, and interpreting data and evidence to understand the level of performance or of some underlying trait or human attributes such as learning, knowledge, personality, behavioral tendencies etc.

“Assessment centers/Development centers”: A process by which candidates are assessed for their suitability to specific roles (typically leadership roles in organizations), using multiple activities or exercises, multiple assessors and multiple dimensions on which candidates are assessed.

“Action”: At every move, the user has the option of taking a limited set of ‘actions’, either in response to the events that have occurred, or proactively, in the pursuit of the user's goals and targets. Actions usually have consequences in the form of changes to organizational data, both intended and unintended.

“Authoring”: The process in Cymorg by which an organization is modeled into the software, historical data is ingested and regressed into the future, and possible scenarios are downloaded or created along with their probabilities of occurrence, mapping with the competencies being assessed/developed, and consequences to the data.

“Cognitive abilities”: Evidence of general intelligence, general mental ability or a ‘g’ factor, which underlies performance on a variety of related tasks and abilities to do with mental functioning including problem solving, reasoning, abstract thinking, logic, concept formation, memory, pattern recognition etc.

“Competency”: A combination of knowledge, skills and abilities, manifested in behaviors of employees at work (used typically in Human Resources, Learning and Development contexts).

“Constructed Response”: A response (in the context of assessments, typically) which the respondent or user creates using their own inputs, instead of selecting from a preexisting set of stimuli. Examples include writing in answers to open-ended questions, speaking a response, etc.

“Context (also, contextual, context-specific)”: The organizational set up and environment with its constraints, data and goals, where the Cymorg experience occurs.

“Data science”: An interdisciplinary field that uses scientific methods, processes, algorithms and systems to extract knowledge and insights from structured and unstructured data, combining programming, machine learning, statistical analyses and content expertise.

“Decision tree”: A decision support tool that uses a tree-like graph or model of decisions and their possible consequences/outcomes; a way to display an algorithm with strictly bounded conditions, perhaps using a flowchart diagram with ‘nodes’ and ‘branches’ like trees.

“Deliberate practice”: Purposeful and systematic practice with the goal of improving performance over time.

“Deterministic”: A system or model where a predictable output is achieved each time, based on strict and static rules, where randomness or probability do not play a role in determining outcomes.

“Development (including employee development, leadership development, management development)”: The process of developing or changing people (employees, leaders, managers) with a specific organizational goal in mind, using systematic or planned efforts such as training programs.

“Empirical/Empiricism”: Based on verifiable observation, data or experience, rather than by theory, rationality or logic.

“Enterprise thinking”: Thinking at the organizational or system level, considering multiple stakeholders, priorities and objectives simultaneously.

“Event”: An occurrence—internal or external to the firm—that is presented to the user as part of the Cymorg experience. An event may have strategic, tactical or no importance to the goals and objectives of the firm. A set of events is presented to the user at every move.

“Expected number of events”: Given a set of independent events that can occur, each with a probability of occurrence, the ‘expected number of events’ is a statistical construct that is defined by the long-run average value of the number of events that occur, given a large number of repetitions of the experiment.

“Expertise”: Expert skill, knowledge, competency in a domain or field.

“Face Validity”: The extent to which the process appears to effectively meet its stated goals or measure what it's designed to measure; the appearance of validity.

“Feedback”: Information about performance or behavior sent back to the individual user, with the intention of helping them improve or change their performance or behavior in the future.

“Functional training/skills training”: Training tailored to a specific organizational function; training focused on the skills or task-relevant knowledge required for fulfilling a specific function at work.

“Games”: An activity or system in which people (one or more players) engage in an artificial setup, characterized by competition or conflict, rules, scoring systems and well-defined endpoints or goals.

“Gamification/gamified”: The application of typical elements of game playing (e.g. point scoring, competition with others, rules of play) to organizational aspects such as leadership development, marketing endeavors or rewards and recognition, in order to enhance employee engagement.

“Gamified simulation”: Simulations (as defined in list below) that have been enhanced with gamification techniques like targets, achievements and group score comparisons, with a view to increasing user engagement and immersion.

“Hidden State Markovian Model”: A statistical model involving a sequence of possible events with the probability of each event depending only on the state attained after the previous event, even though the state itself is not directly observable by a user.

“Industrial-organizational psychology/work psychology”: Industrial-organizational (I-O) psychology is the scientific study of working and the application of that science to workplace issues facing individuals, teams, and organizations; applying the scientific method to investigate work-related problems.

“Item”: A specific unit of responding on an assessment or test—e.g. a problem, a question or a statement to which an individual provides a discrete response.

“Likert”: The most commonly used rating scale in survey research, named after its inventor Rensis Likert, in which respondents indicate their attitudes or opinions on a continuous multi-point scale (typically 5 or 7 points of agreement/frequency).

“Machine learning”: A field of computer science where statistical techniques are used to give computers the ability to perform tasks without being explicitly programmed.

“Measurement”: The assignment of a number or value to a characteristic of an individual, an object or other construct, to allow for comparison and easy understanding of the operational meaning of these constructs.

“Move”: A period of virtual time—typically either a quarter or a month—within which a set of scenarios are presented to the user and their responses are collected. Once the responses are in, the simulation proceeds to the next move, or virtual time period, or the simulation ends.

“Multiple choice format”: An item or question type in testing/assessment, which consists of a problem (the stem) and a list of suggested solutions, known as alternatives, one of which is the correct or best alternative and the remaining are incorrect or inferior alternatives, known as distractors.

“Node”: Within a decision tree model, a node represents a decision point—the decision node represents the choice at that point, resulting in ‘branches’ which are the outcomes/consequences of that decision, and the leaf nodes are the labels of those decisions.

“Norm”: A result of ‘norming’—a process by which a group aggregate is derived, and individual scores are able to be compared to each other, using their relationship to the group ‘norm’ or relative performance.

“Off-the-shelf”: Ready-made (not designed or created to order; not custom-made or bespoke, but generic) solutions that are meant for generic/universal application without any customized features or functionality.

“Paradata”: Data collected about the usage of the system, which can be analyzed for meaningful insights into the user's preferences, priorities and styles of decision-making.

“Partial Credit”: A scoring system or model, where each response receives some proportion of the maximum possible score and need not receive a binary pass/fail or yes/no result.

“Percentile”: A number that indicates the percentage of observations that fall below that value, in that specific sample or group of observations.

“Person X Situation framework”: Framework used in the present method which analyzes competencies in terms of the interplay between the characteristics of a person (traits, preferences etc.) and those of a situation (market and organizational context, goals, values, strategic levers, etc.). In psychological theory, the Person X Situation framework describes the interaction between person-specific, dispositional influences and situational, environmental influences on behavior.

“Personality”: The constellation or organization of dispositional traits that define a person and represent their particular and characteristic adaptation to their environment.

“Preset average number of events”: In the present system, the number of events presented to the user for response is allowed to vary at different stages of the simulation around an average value that is set as part of the configuration effort. The number of actions that the user is allowed to make is typically a fixed number that is equal to this average number of events. This allows for analytics around situations where the user has to prioritize among a larger set of events than allowable actions, and where the user has more actions available than events to respond to.

“Psychological Fidelity”: The extent to which the psychological processes, feelings and behaviors (such as engagement, decision making, excitement, achievement, defeat) involved in a simulated or virtual experience are faithful to the real experience.

“Psychometrics”: A field or area of study within psychology, concerned with the objective measurement of human psychological characteristics such as skills and knowledge, abilities, attitudes, personality traits, and educational achievement; the construction and validation of assessment instruments such as questionnaires, tests, raters' judgments, and personality tests for the objective measurement of psychological characteristics.

“Psychometric Tests”: Tests of psychological attributes such as intelligence, personality and aptitude that have predictive power for academic or work-related performance.

“Realistic job previews (RJPs)”: A tool used by organizations to communicate the good and the bad characteristics of the job during the hiring process of new employees, including sharing information such as work environment, job tasks, organizational rules and culture etc.

“Relative likelihood factor”: A multiplicative factor used in the present method, that is applied to the probability of events in any discrete probability level to obtain the next higher level. The higher this value is, the smaller the percentage of low probability events being picked up by the simulation engine, and so, the less ‘surprising’ the experience will be.

“Sandbox”: Cymorg's experimental virtual environment with realistic features and data, to simulate a real organizational set up, where users can navigate issues, address problems, pursue goals, interact with data and other users etc. just like they would in reality, but with an option to retry and experiment with new approaches each time.

“Serious games”: A game designed for a purpose apart from pure entertainment; applications include learning, assessment, realistic previews and simulating reality; widely used in defense, education, healthcare, emergency management, organizational leadership development etc.

“Simulations”: Virtual imitation of a real process or system, including organizational systems; Business simulations involve presenting users with business/organizational challenges and context-specific goals, and following how they navigate the simulated context.

“Situational judgment tests (SJTs)”: A type of psychological test where the respondent is presented with a realistic scenario and asked to choose their ideal or typical response to that scenario from a few alternatives.

“Skills”: A domain-specific ability and capacity to carry out specific tasks or activities, that may be acquired and grown through deliberate effort or practice.

“Standardized scores”: Methods to convert scores on different scales or distributions to make them comparable; placing them on the same scale (e.g. z-scores or standard scores).

“State of health”: Organizational health for a firm may be measured along a variety of standpoints—financial, regulatory, competitive, customer relationships, employee loyalty etc. For each of these, the condition of the firm at any juncture can be determined by the values of one or more data elements. The entire region of possible values for these data elements can be divided into zones called “states”. When the firm transitions from one state to another, because of a user action or the consequence of a probabilistic event that took place, future events can become more or less probable.

“Sten Scores”: ‘Standard Ten’ (Sten for short) scores are standardized scores which allow scores from different scales to be compared; they are derived using the normal distribution and z-scores, which divide the distribution into ten parts; the average Sten is 5.5 and represents the midpoint of the distribution.

“Trajectory (of change)”: In the present method and system, it is possible to track change over time and across instances, of individuals as well as groups. These changes can be plotted as curves or graphs—trajectories—showing growth or consistency, for individuals or groups.

“Trends”: As part of the authoring process, historical data is collected for every parameter or data element that is tracked as part of a Cymorg simulation. Statistical regression techniques are applied on this data to determine a best-fit curve which can then help project this data into the virtual ‘future’. These projected values, based on historical data, are the ‘trends’ for the data item. If no scenario and no user action affects that data item, the assumption is that the trends would continue from the past.

“Threshold state”: For every category along which the health of the organization is measured, one of the zones can be designated a Threshold State. When the organizational values transition into the threshold state for any of the categories, the simulation comes to an end.

“Unstructured/Dynamic”: Descriptive of an assessment where the stimuli (e.g. test items) is not a fixed list but varies based on prior participant responses and/or other probabilistic considerations.

“User”: The participant or player of the Cymorg gamified simulation, the person who navigates the simulation and receives reports on her/his performance in it.

“Virtual”: A digital replication or close imitation of reality.

“Work sample tests/Assessments”: Assessments that require one to perform tasks similar to those that will be used on the job in question.

The disclosed embodiments include several special terms and examples—they are for illustrative purposes only. For example, the terms and use of “gamified simulation”, “state of health”, “expected number of events”, “relative likelihood factor”, “preset average number of events”, “person-situation” model of competency and “paradata” etc. are meant as stand-ins for the concepts described, not for the narrow, specific use herein for Cymorg. The name Cymorg is not meant to limit the use of the terms and concepts in any way. The disclosed embodiments refer to “market,” “profit,” “enterprise,” or the like. However, it should be understood that the inventive concepts may be applicable more generally to organizations which may be analyzed by the principles of management described herein.

In embodiments of the inventive concepts, Cymorg is an online system, available in on-the-cloud and on-premise models, as well as the method of creating this system. It is designed for use in the context of an organizational decision-making.

Provided below in this section are the details of: The product (including its architecture, and access); its use, including the experience delivery method (calculating base trends, states of health, events, actions and consequences); the methodology of event picking with illustrative event picking examples; and, the method or framework for measurement, including behavioral competencies, conceptualized as complex person-and-situation interactions; the harnessing of ‘paradata’ for information processing and communication indices; analyzing constructed responses, as well as trajectories of change.

The Cyborg system consists of the following architectural components. REST APIs (Representational State Transfer Application Programming Interfaces), through which the processing is available to the user interface layer. The cache is a layer that extensively caches (temporarily stores/accumulates) all master data, configuration, game states, etc., to enhance speed of access and processing. Databases include, for example, a transactional database, a secondary database for disaster recovery and a reporting and analytics data store. The Game Engine includes various components that work together to implement the core processing logic. The Data synchronization service keeps the Cache and Databases in sync.

When an organization implements the Cymorg system as their platform for assessing and developing user attributes and decision making, a separate instance of the system is created for that organization, hosted either on the cloud or in the organization's own premises. One or more designated “admin” users are created in the system at the time. These admin users can thereupon Model their organization in the system by defining its structure. The admin can define the configuration settings: time limits for the users (i.e. the individuals ‘playing’ or experiencing Cymorg), individual or group-based experience, number of stages in the simulation, number of events encountered per stage, etc. The admin can decide which data elements (“parameters” such as profits, sales, employee satisfaction—as examples) are important for their purpose to be tracked and at what levels within the modeled structure the parameters are to be stored. They can incorporate real, historical or fake (i.e. “play”) data for these parameters from organizational repositories and other sources. Based on the specific objectives of the users being assessed and developed, their seniority and functions, and the context of the firm, the admin decide on a set of work-relevant scenarios (events and action options) that are suited for purpose. They can choose from an available library of scenarios in the system, modify it, or create a new scenario from scratch. They can finalize the design, and create user IDs and passwords.

Once the design is finalized, the users (participants or “players”) may access the system using their user IDs. They are given a brief tutorial about system features, and initial information about the status of the organization, their own role and the targets they need to achieve, time to assimilate this information, and then to create plans for achieving their targets, and budget for those plans.

The simulation begins with the setting of a “virtual calendar” to the first stage (week, month or quarter, as pre-configured) of the simulation duration. A set of events is made available to the user, and the organization data set to be changed based on the impact of those events. For each event, the user can analyze the available data, seek advice, read up about the issue on external sites, then choose to ignore the event, respond to it or take a completely unrelated, proactive action. When the user exhausts the number of actions she/he can take in a single move, or chooses not to avail of her/his full quota of actions, the simulation moves to the next stage (week, month or quarter, as configured), and the system generates a new set of events based on the impact of the actions of the previous stage(s) as applicable. Changes are reflected in the newly visible data, and these new values are made visible on the user dashboard.

If at any time, the organization slips below pre-designated threshold values for certain combinations of data elements, the game ends unsuccessfully (e.g. the financial health of a certain organization may be measured as the combination of its Profit After Tax figure and its monthly Growth in Revenues, and if both these drop below defined numbers, the game ends). Otherwise, it ends when the last stage of the simulation is successfully completed, or when time runs out (in case the configuration stipulates a time limit). Analytical reports can be generated after the game.

Cymorg is novel compared to games or activities that allow “playing” with management issues and decision making in several important ways. Cymorg is a dynamic platform, not static, where all organizational data is subject to change at every move. Furthermore, Cymorg is customizable to the changing situations of a particular organization. As described above, the organizational data of interest is input at the outset by the user, who also steers the decision-making moves with as much information made available as possible by the computerized play. Cymorg incorporates the distinctions between acceptable and unacceptable outcomes by measuring the likely impact of simulated decisions through the flexible parameter, “state of health” of the organization, which is defined and described in the States of Health section below.

In order to create realistic experience for the user, the methodology of Cymorg relies on several, customizable variables and parameters. These include the historical “trends,” quantified “states” of organizational health and a framework of risks and rewards, which are described next, along with a flexible method of quantification and computation.

The Cymorg method involves modeling the organization structure and ingesting as much historical/context-specific data as is deemed necessary for realism and relevance. This could be data pertaining to the organization's finances and cash flow, market data pertaining to customers, competitors, partners, vendors, regulators and other market entities, or, internal data pertaining to the employees of the organization. These data projected into the future using extrapolatory statistical techniques (simple regression, for example), and the ‘base trends’ for each of the parameters tracked are calculated. It is assumed that the organization would continue to exhibit these trends, in the absence of any new external or internal events. Currently there are no limits on the number of parameters Cymorg can accommodate—however, practically one usually ends up with 50-80 parameters to model.

In an embodiment of the inventive concepts, the historical data in Cymorg may be generated by data feeds but the source of these data feeds could be any available source with probable downstream impact on the “game,” including any or all of the following: (a) Organizational data either sourced from public domain filings of the organization, or explicitly provided by the organization from their internal accounting and other systems, (b) Industry, and market data that is considered relevant for decision-making by the organization, sourced from publicly available information like stock market price movements, currency exchange rates, unemployment, housing prices, inflation and other economic indicators, or (c) Customer behavior and Competitor related financial and product information sourced from organization's own repositories or from internet research.

The system can also work with fictitious organizations modeled for the purpose of use in the system, with imaginary, realistic looking but “dummy” historical data fed into it before the system is available to be experienced. Additionally, while there are no minimum number of data points required to create this ‘history’, and one could merely specify just the current state—that might mean there wouldn't be trends generated for this historical data, which would be a static value until the user starts impacting the value within the Cymorg game experience itself.

In further embodiments, certain elements and/or types of the data, e.g., trends for social sentiment and job market and market perceptions about the organization and its products and leadership, may be generated directly and automatically, by means of using techniques such as data scraping, or machine learning enabled analytics, based on the organization's mentions in relevant public media and social media sites.

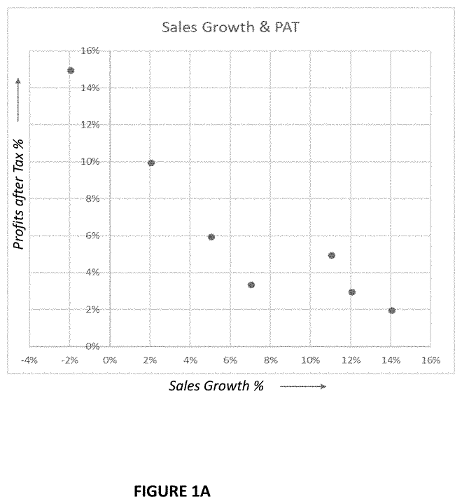

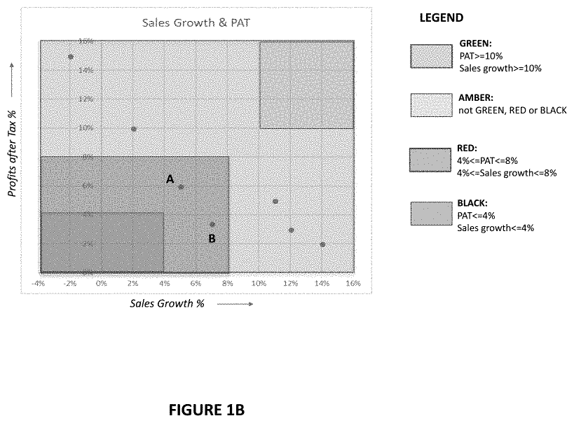

The next step in configuring the system is to define a set of “states” that determine the “health” of the organization along several different dimensions: employee satisfaction, customer loyalty, investor confidence, regulatory landscape, social goodwill, etc. The state of health along any dimension is measured by means of the current values of certain variable parameters, by themselves or in combination. As an example, see FIG. 1A, the financial health of a certain organization may be measured as the combination of its Profit After Tax figure and its monthly Growth in Revenues.

Referring now to the drawings, where like elements are designated by like reference numerals, in FIG. 1A, the Y-axis depicts Sales Growth and the X-axis depicts that Profit After Tax of the organization at the end of a month. At any juncture in the game, the “virtual organization” has distinct values for both these parameters, and so the financial health of the organization correspondingly is represented by a point on the Sales Growth & PAT scatter plot. This point moves across the 2-dimensional graph as the simulation proceeds and PAT and sales data change month by month.

It is possible to identify regions in the graphical space as representing different “states of health” of the organization. FIG. 1B shows the graph of FIG. 1A segmented into the following four regions, where identifying color in the name is for convenience only: (a) A “Green” state of health, defined by PAT>10% and Sales growth>10%; (b) A “Black” state of health, defined by PAT<=4% and Sales growth<=4%; (c) A “Red” state of health, defined by 4%<PAT<=8% and 4%<Sales growth<=8%, and (d) An “Amber” state of health, defined as not green, not red and not black. Most of the points in this particular example lie in the Amber region, except for two in the red zone.

This simple example illustrates a 2-parameter definition of Financial health, with the scatter graph divided into four zones or regions. It is possible to define the Financial health or any other ‘state’ of an organization using a combination of the values of any number (n) of different parameters. Once you can visualize an n-dimensional scatter graph, you can divide the space into mutually exclusive regions or zones, such that they collectively fill the entire space without overlapping. Then, the simulation at any single juncture, will have values defined for each of the n parameters, and so can be represented by a single point on the n-dimensional scatter graph. The zone in which that point lies defines the state of health of the game on that parameter. Similarly, one can define the Market state of Health, the Investor State of Health, the Customer state of health, or other such categories. At any juncture, for any category along which we are measuring health, the simulation is in one (and only one) zone.

Thus, at any time in the simulation, an organization's state of health can be measured along several categories, but for each category, there is one, and only one, unambiguously defined zone in which the organization lies. Therefore, the likelihood of a particular scenario taking place can be attached to the value of the state of health of the organization along any one of the categories: certain events are more likely to take place under certain circumstances than under others. For instance, a steep drop in share price is an event that is less likely to happen when the state of financial health is in the Green state than when the point is somewhere deep in the red zone.

For every category, it is possible to designate the zone with the combination of the worst outcomes (e.g., the “Black” state of Financial health in the example above) as a Threshold State. When the simulation point falls within the threshold zone, the simulation comes to an end, and the participant's effort is deemed “unsuccessful”.

Events, Actions and Consequences are described herein. When events are authored into the game, their probability of occurrence is attached to these states of health. When an event takes place, it can change the value of some financial and other parameters. The participant, in response, may take an action, which will have intended and unintended consequences for the value of the parameters. Because of the changes in data values, the state of health of the game, along each of the dimensions, may undergo a change. When that happens, the probability of the various possible events may change, as well. The engine then picks the most probable events in the new state of the game.

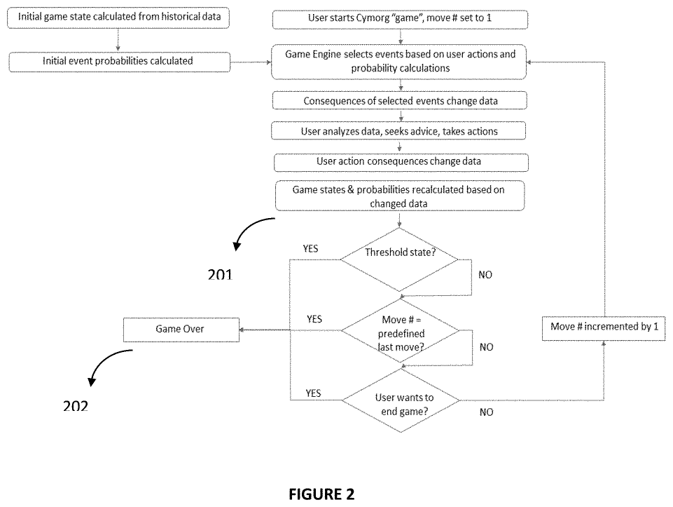

Referring to FIG. 2, it shows the overall flow of the simulation's progress by the process steps and sequentially marked arrows. As part of the authoring/configuration stage, historical/contextual data of the organization is used to generate base trends for every parameter being tracked; these trends are used in projecting the data into the “future” in which the simulation will be run next. The values of the data elements being tracked are calculated as part of the projection process. The various states of health of the organization along each of the pre-defined categories at that juncture are calculated.

Based on the states of health, the relative probability of all available events is calculated, some of which would be highly probable to occur, others less probable. The system is pre-configured to run for a certain number of “moves” or virtual time periods. When a user begins using the system, the move number is set to 1. Based on the number of available high, medium and low probability events, and the average number of events required to be picked, the actual probability of the events is modified while keeping their relative likelihood the same; then, events are “picked” from the list by choosing random numbers and comparing them against the probability of each event. When an event is “picked”, it can change the value of some of the parameters being tracked, both immediately and over a longer term; the values of all the data elements and the states of health are re-calculated. Based on organizational goals, targets, market context, etc., and the knowledge of the events that have taken place, the “player” takes an “action”, by which she/he tries to deliberately change the value of one or more parameters. The system is designed to have both intended and unintended consequences of the user action taken. Depending on the states of health of the organization at that juncture, the actions may affect the parameter values in different ways. The parameter values are recalculated after the impact of the actions is taken into account. The states and probabilities of all available events are recalculated 201 after the changes caused by the action consequences. If the organization has transitioned into a threshold state, the simulation comes to an end, and the user is deemed unsuccessful at completing the game. If the user wishes to continue, the simulation moves into the next “move”, and the cycle is then repeated from step 4 above, until the move number reaches the pre-assigned maximum value. The process stops when the game is ended 202 by the user/player/participant, or when a pre-defined number of “moves” or event-action loops is completed successfully, or when a pre-defined threshold state is breached in any category, indicating an unsuccessful completion.

As to adjustment of probabilities during recalculation, authors may note during authoring that some events cannot happen more than once in a game, so if they have occurred, their probability goes to zero. Other relationships also hold true—a few events are mutually exclusive (if one of them occurs, the rest cannot and their probabilities reset to zero) and a few are triggered directly by one another (their probability goes to one after a designated lag), overriding the ‘ state of health’ derived presentation of events in this case. The Markovian model ensures that the entire information about all past choices and events is encoded into the current state, thus taking away the need for elaborate decision trees of sequences. That said, the method still needs to figure out an efficient mechanism for “picking” the most probable events from the event set, reducing it to a manageable and predictable number, and “making them happen”.

For the game to be interesting, a very large number of events has to be available, but only a very small number should be visibly in the play per move. This small number can vary a little but not too much, around a pre-set average value. From empirical considerations, we try to ensure that the number of events that we put in front of a participant at any one time, is a number that is less than 6 or 7. The number 7 is recommended based on the long-established idea that this is the average capacity of short-term memory—we process about 7 units of information (plus or minus 2) (e.g. Miller, 1956). [Miller, G. (1956). The magical number seven, plus or minus two: Some limits on our capacity for processing information. The psychological review, 63, 81-97.] We may then be able to make interesting insights from observing how participants prioritize between these events. (This number ‘7’ is recommended, but not fixed and is completely configurable based on requirements). It is impossible to know before the game begins what the number of available events will be before a particular move, and what their individual probabilities of occurrence are going to be. Hence, the method needs to perform calculations before every move to ensure that a manageable number of events is chosen in that move.

Let Eⱼ=the expected number of events that take place in the j^{th} move. Let Pᵢⱼ be the probability of the i^{th} event taking place in the j^{th} move and let there be Nⱼ events available to be picked. Then we calculate

Eⱼ=ᵢ₌₁Σ^{N}Pᵢⱼ

(by analogy, if we are rolling 10 unbiased dice and wish to calculate the expected number of sixes, we will find that it is 10*(1/6)=1.67)

We need to figure out event probabilities such that we can expect a manageable number of events to take place. At all times, the core principle is that vastly more probable events should occur far more times than very unlikely events. To ensure this, we took a “quantized” view of probabilities to begin with. Instead of allowing probabilities to be evenly spaced all over the (0,1) space, we allow for only a certain number of discrete levels for the probability of an event: for instance, “highly probable”, “moderately probable” and “highly improbable”. In this example, Pᵢⱼ's can only take 3 values: a very high value (designated Pₕᵢ), a very low value (designated Pₗₒ) and a moderate value in between these (designated P_{med}). While we have used 3 levels in this example, our approach can be generalized for any given number of discrete probability levels.

To differentiate strongly between highly probable events, moderately probable events and highly improbable events, we further stipulate that

Pₕᵢ>>P_{med}>>Pₗₒ

In other words, the high probability events are much more probable than the moderately probable ones, which in turn, are much more probable than the improbable ones. To confirm this, we define a factor F such that

Pₕᵢ=F*P_{med}.

P_{med}=F*Pₗₒ

For instance, for F=9, we have Pₕᵢ=9*P_{med}=81*Pₗₒ

In this example, if a “low probability” event has a probability of 0.01, the “medium probability” events would have probability of 0.09 and the high probability events would have the probability of 0.81.

F is the Relative Likelihood factor, and indicates the degree of surprise in the game. The bigger the difference between likelihood of high probability events and that of low probability events, the greater the proportion of high probability events that get selected. Thus, the higher the chosen F factor, the more we will get highly probable events chosen every turn. When F is 10 or higher, for instance, the low probability events are less than 100 times as likely to get picked as a high probability event. Where a small number of events is to be selected from a large available set of high, medium and low probability events, very few, if any, low probability events will get picked.

On the other hand, the lower F is, the more the number of ‘black swan’ low probability events sneaking into the game. In the limit, when F=1, we get a perfectly random chaos with every event being a surprise. When F<1, we enter an outer darkness where madness lies, and where the events that take place are the exact opposite of what we expect. At F=0, nothing happens. No event takes place.

Somewhere between that terrible fate and the boring simplicity of absolute predictability, lies a complex world where a user may find events one expects to see most of the time, but may still be occasionally surprised by something unexpected. This situation closely resembles real life. Now the problem reduces to this: how can we control the expected number of events, with the ‘high probability’ events showing a significantly higher frequency of occurrence than the lower probability events?

Two other alternatives considered and rejected as unsatisfactory for logic of selecting events were (1) shortlisting events to ‘take place’ based on random number generation and the probability of each event, but picking at random only a preset number of events from the shortlist; and (2) making the simplifying assumption that the probability defined is not that of an event happening, but that of an event happening GIVEN that a certain number of events must occur (in other words, reducing it to a ‘draw-x-balls-from-a-bag-of-balls-without-replacement’ problem). Both options are artificial and unrealistic in mandating a specific fixed number of events to take place every move, regardless of the probabilities of the events available. The procedure below has been invented to ensure that a realistic experience is maintained while staying true to the relative likelihood of the available events.

For the j^{th} move, let there be a total of Nⱼ events available for selection. Some of these events will be high probability events, some medium probability and the rest low probability.

Let Nⱼ=N_{j,hi}+N_{j,med}+N_{j,low}

N_{j,hi}=number of high probability events available in move j, N_{j,med}=number of medium probability events available in move j, and N_{j,lo} are low probability events that are available in move j.

Since in our model, all the high probability events have the same discrete probability value Pₕᵢ, all the medium probability events have the same probability P_{med} and all the low probability events have the same probability value Pₗₒ, the expected value for the number of events taking place in move j is:

Eⱼ=(N_{j,hi}*Pₕᵢ)+(N_{j,med}*P_{med})+(N_{j,lo}*Pₗₒ)

As discussed above, the aim is to have a small number of events, varying around a small expected value to be picked by this process. Thus, the problem reduces to finding the probabilities Pₕᵢ, P_{med} and Pₗₒ such that the expected value of events that will take place is the number we want, while continuing to maintain the Relative Likelihood Factor F.

To make Eⱼ=a preset number k, we multiply all probabilities by the fraction k/Eⱼ, to arrive at a new adjusted probability for each event. This will maintain the relative ratio between the event probabilities but will also allow for a realistic variability in the number of events per move. In order to make Eⱼ=a pre-set number k, we set

Pₗₒ=k/(F²*N_{j,hi}+F*N_{j,med}+N_{j,lo})

P_{med}=F*Pₗₒ

Pₕᵢ=F²*Pₗₒ

By knowing k, the pre-set average number of events to be picked, the number of high, medium and low probability events available (Nₕᵢ, N_{med} and Nₗₒ), and the multiplication factor F that distinguishes the probabilities of events, we can then solve for what the individual probabilities need to be. Once we have re-calculated the probabilities of individual events in this way, their relative likelihoods continue to be the same as before, while the overall expected value of events to be picked reduces to the number we want. We then “pick” events according to method:

For each event E₁ in the list of N available events
Choose a random number R in the (0,1) space. Once we have re-calculated the probabilities of individual events in this way, their relative likelihoods continue to be the same as before, while the overall expected value of events to be picked reduces to the number we want. We then “pick” events according to method: If R<=P(Eᵢ) consider Ei “picked”.
Else, Ei has not been picked

Described herein is an example for event picking. This section demonstrates how the method works with different distributions of events with high, low and medium probabilities. In each example, events are picked 60 times in the method described, with an average of 3 events to be picked at any one time. The desired result is that more probable events get consistently picked more often than less probable ones, but that some moderately probable events and the odd low probability event also do get picked up once in a while.

Let us, as an example, take a sample of 100 events: 4 high probability events, 36 medium probability events and 60 low probability events. Let us assume an F factor of 9 (in other words, high probability events are 9 times more probable than medium-probability events, which in turn are 9 times more probable than low probability events)

Then, Pₗₒ=3/708=0.0042

P_{med}=0.0381

Pₕᵢ=0.3432

Now, when we run the simulation, we get:

Maximum events per move=8

Average events per move=3.03

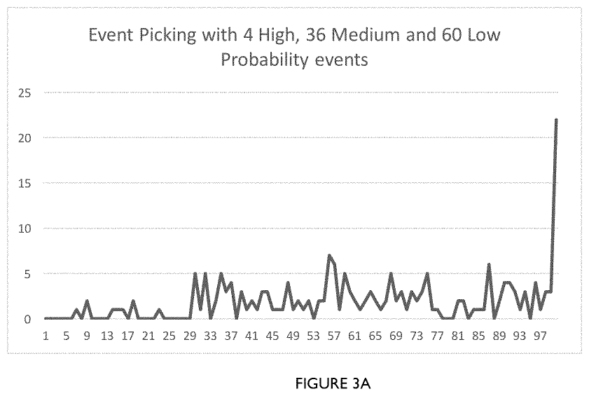

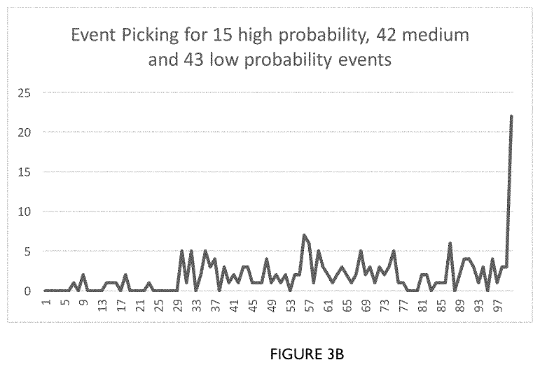

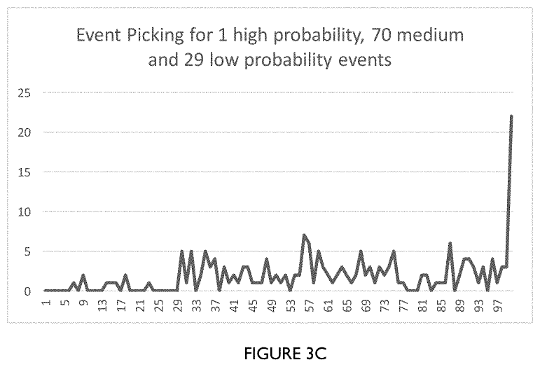

Case 1, depicted in FIG. 3A. FIG. 3A shows which events were picked up. The 4 high probability events are 97-100, and the first 60 events are the low probability ones. Over 60 moves, a total of 181 events were picked up. Of these, 46% were high probability events, only 6% were low probability events (despite only 4% of all available events being high probability, and 60% of all available events being low probability).

Case 2, depicted in FIG. 3B. For the same example: A different distribution: where N (hi)=15, N (med)=42, N (low)=43. Because there are 15 high probability events, and only 3 are getting picked at any time, chances are that almost always only high probability events will get picked.

Here Pₗₒ=3/1636=0.0018

P_{med}=0.0165

Pₕᵢ=0.1485

These are the results of the simulation:

Maximum events per move=6

Average events per move=2.82

When we ran the Cymorg event picking engine, the results were as depicted in FIG. 3B. The 15 probable ones feature prominently. Each high probability event occurs at least 6 times), and in total, high probability events account for nearly 80% of all events picked. The moderate ones do get a look in now and then (none more than twice), and once in a blue moon, we see a few very unlikely events take place as well. There's something in it for everyone.

Consider Case 3, depicted in FIG. 3C. For our last example, depicted in FIG. 3C, we will choose a distribution with 1 high-probability event, 70 medium-probability events and 29 low-probability events. The one high probability event took place 22 times (way more often than any other event, but only 11% of all events that got picked up). Because 70% of all events were mid-probability events, most of the events that took place were mid probability events (accounting for 83% of all events), while the low probability events, though 29% of the total available events, only occurred 6% of the time.

The method under discussion involves assigning event probabilities in 3 (or 4, or 5, or any small number of) discrete levels only, where each probability level is a multiplicative factor more likely to occur than the next rarer level, and to adjust the expected value for the number of events likely to take place to a pre-set average number, by applying an adjustment factor on the probabilities. This allows for the following. (a) Easier set up of new games, by making the probability choices easy to choose (b) Delivery of a slightly varying number of events in every move, within a manageable number. (c) High probability events at all times to have a much better chance of occurring than medium or low probability events. These allow the invention to simulate reality to a much better extent than existing solutions do.

Described herein is a measurement framework for dynamic gamified simulations. Cymorg is a digital platform for dynamic, gamified simulations that may be used to assess and develop people using contextual realism, dynamism, and a focus on simultaneity of pursuits and a holistic experience. While such an experience is unique and valuable because of its contextual realism and rich mimicking of real work experiences, there are challenges in scoring or measurement of human attributes and decision-making processes given this complexity. For instance, given the numerous possibilities in terms of the user's responses, each of which has probabilistically determined impacts on downstream events and consequences, no two experiences (even of the same user) are likely to be identical or even similar. Thus, comparisons across and within people are difficult and careful calibration is required to ensure that inputs are scored appropriately. Also, in the absence of a clear ‘question-answer’ format, what elements of the experience should even be scored? Thanks to technology, it is possible to track and record hundreds of data points each minute—these game play logs or ‘click streams’ record every action taken (such as asking for help, reading instructions, taking action within a certain time etc.) which affects the running state of various indicators of success or failure. Processing such data require data science and analytical approaches not usually employed by traditional psychometric assessments or solutions.

An embodiment of inventive concepts provides a framework or a structure of making reasoned inferences from a dynamic, gamified simulation, in the absence of structured measurement maps between user behavior (choices, responses, decisions made, clicks used, time taken, actions prioritized etc.) and meaningful scores on outcomes of interest (behavioral competencies, predictions of success or failure in similar situations, choice preferences, development trajectories etc.). In order to fully leverage the measurement potential of such simulations and their “point to point correspondence” or the extent to which they reflect or correspond to real life, one needs to attend to what is called “simulation complexity,” in which the external experience and the internal design (how the simulation progresses and is scored) are aligned in terms of their complexity. The measurement framework therefore, is intimately tied to the simulation experience to maximize simulation complexity.

At the outset, Cymorg will be able to provide descriptive analytics, based on sound theoretical and rational frameworks. Over time, as more data is collected and decision science and analytics are leveraged to further advantage, the reports will incorporate predictive and prescriptive insights, realizing the full promise of sound substantive frameworks combined with technology and analytics to provide complex forecasting models.

The following paragraphs describe this measurement method: a new operationalization for human behavioral competencies measurement, a method of using paradata to evaluate human information processing as well as communication patterns in organizations, using text analytics methods to assign scores for constructed responses, and identifying trajectories of change over time and across people.

Research in psychology has established that human behavior is a complex interplay between nature and nurture in general, and in any given instance, between the person's dispositional attributes (such as personality, motives, values, attitudes) and situational factors (such as pressures to conform, to evoke biases or stereotypes, to act in self-interest or obey authority, etc.) (e.g. Buss, 1977). [Buss, A. R. (1977) The trait-situation controversy and the concept of interaction. Personality and Social Psychology Bulletin, 5, 191-195.] Assessments used in organizational settings, such as for hiring, for providing developmental feedback or performance management, often use competency models or frameworks (sometimes referred to as performance dimensions frameworks, leadership frameworks or behavioral competency models) as the foundation for these (Campion et al., 2011). [Campion. M. A., Fink, A. A Ruggerberg, B. J., Carr, L., Phillips, G. M Odman, R. B. (2011). Doing competencies well: Best practices in competency modeling, Personnel Psychology, 64, 225-262.] A common understanding of competencies is as combinations of knowledge, skills and abilities, which have behavioral manifestations. These are therefore often conceptualized, written and assessed, using behavioral anchors or defined/operationalized as behaviors. E.g., a commonly occurring competency is ‘effective communication’—and this may be operationalized in a performance ratings form as the behavior of “communicating in a clear, direct and impactful manner.”

Since such behaviors are actually the result of both person-specific and situation-specific influences, it is advantageous to also measure them as such. The current invention, therefore, reimagines competencies to break down the behavioral elements (that which is observable), into its component parts in two major steps at the time of design: (1) using competencies as the building block from which to create scenarios or situations within the simulation, and (2) assigning weights (i.e. offering ‘partial credit’—or some proportionate weight or score) that represent the ‘saturation’ of these competencies in various situations as well as individual actions.

In this manner, using theoretical knowledge and rational judgment by subject matter experts such as organizational leaders or HR/leadership experts, the design of the simulation itself includes behavioral competencies as a combination of person and situation influences. In other words, this invention captures a measure of a complex person-by-situation interaction, which considers the ‘appropriateness’ of each response or individual behavior with respect to the event that called for it, instead of considering the behavior or the event in isolation.

Ultimately, for an individual playing the simulation, scoring algorithms that use this conceptualization, produce end reports that summarize their position on various competencies. This is described further herein. During the design/setup/authoring phase of the simulation, each scenario or event is assigned a weight or proportion—the partial credit—(e.g. from 0 to 1) according to the saturation of various competencies in it. For instance, an event like “The VP of Sales in the North announces that she/he is leaving you for a competitor” has various elements to it so it may be assigned various weights against different competencies (e.g. 0.8 for “Managing Others”, 0.6 for “Business Acumen” and 0.6 for “Customer Focus”). Various possible actions or responses may be generated or may exist in the simulation's library. Several of these may apply in any given case. These actions would vary in terms of their appropriateness for each event—and this match itself is saturated with how much of a competency is in play in that choice. E.g., for the event above, an action like “Meet personally with the VP of Sales immediately in an effort to retain her” is high on the competency “Managing Others”—(perhaps 0.8), and somewhat high on the competency “Influence” (perhaps 0.6) but does not even tap into the competency “Innovation”, or has only an oblique bearing on it, and thus is not assigned a weight for it. Another action like “Request the CHRO to speak with the VP of Sales” may be lower on the competency “Managing Others”—perhaps only a 0.4. Thus, every event/scenario and event-action pair will be mapped to a set of competencies, using weights that signify the amount or saturation of those competencies in these events and event-action pairs. During the gamified simulation, if the user sees an event and takes an action in response to it, this will trigger a score for all the competencies that have been mapped in the above-described manner. This score is the multiplicative product of the weight of the event, and of the event-action pair, divided by the maximum assigned weight for that event (to control for the fact that for some events, perhaps there are more appropriate responses than for other events). For instance, in the running example, if someone selected the second action—“Request the CHRO . . . ”, their score would be (0.4*0.8)/0.8 i.e. 0.4 but for someone who selected the first action—“Meet personally . . . ”, their score would be (0.8*0.8)/0.8 i.e. 0.8. Across all the user's actions in the simulation, therefore, a running tally of competency scores will be created. Their ultimate score on each competency will be that total divided by the number of events that tapped into that competency (i.e. an average). This score can be converted into standardized scores such as stens, percentages, even percentiles if normative groups are available for cohort comparisons or norms.

Further, because Cymorg's games are dynamic and not pre-scripted, it may happen that over the course of a complete simulation, some players do not receive events that sufficiently test their scores on one or more of the competencies. Thus, some of the competency scores may be the effect of a large number of data points, while others may the effect of just one or two. To prevent this from happening, it is possible the system allows authors to configure a simulation in the following manner. RULE 1: Define a weightage (between 1 and 10), as the minimum weight beyond which an event can be called an adequate measure of a particular competency. RULE 2: Define a minimum number of total actions within a game that indicate a particular competency, and a minimum number of actions pertaining to an event that is an adequate measure of a competency. At the end of a game, if there are any competencies that have not adequately tested in that game according to RULE 2 above, the game reports system will not publish scores for that competency in the game reports.

In order to maximize competency coverage in every single game (i.e., to minimize the number of competencies for whom insufficient testing has taken place), we have added logic in the core engine, that overlays the event picking logic described in sections above. By this logic, The engine picks a set of events for every move, checks to ensure that at least one of the picked events is an adequate measure of a competency that has not yet been “covered” adequately. If on the other hand, it finds that all the picked events of the move have already been measured adequately in this game, it would discard all the picked events, and try again. While this method is not infallible, it is likely to minimize the risk of complete games not having adequate coverage of all competencies.

The aspect of human information processing of the invention assigns scores to prioritization within the gamified simulation, using a logical point scheme that leverages the internal engine and design of the simulation. The point scheme is deliberately generalized in order to be flexible and accommodate changes to variables it uses, while also retaining uniqueness and specialization in its logic/rationale for scoring.

Within the gamified simulation, a number of events can occur simultaneously within a ‘move’ (a unit of time within the simulation, such as a month, or a quarter), just like in real life. These events can be a mix and can be tagged by the most representative ‘category’ (domain, area, aspect of interest) a priori. As an illustration, each event in a simulation about a global multinational software services organization may be tagged as belonging primarily to a category such as ‘customer’, ‘investor’, ‘finance’, ‘employee’ or ‘market’.

Stipulate the following, as a precondition to explaining the generalized scheme for assigning points to users' actions within the simulation. If ‘m’ number of events occur during a move, they may all belong to the same category, or all belong to different categories, or some combination thereof. Prioritization is always relative in nature. By selecting one action/option, the user is automatically de-selecting other options. When a user responds to an event tagged to a certain category, that response or action results in the respective category gaining (or losing) the assigned number of points. At the end of the simulation, the cumulative number of points per category provides an indication of relative prioritization.

In the generalized point scheme, there will always be a fixed number of actions, ‘n’, possible per move. There will be a variable number, ‘m’, of events per move. The average number of events per move will be equal to ‘n’ also. The minimum number of events per move will be 1 (one) and the maximum will be N (where N>n). The number of points awarded during an event that is picked for response, depends on the number of other options the individual had at the time of the choice (i.e., if s/he had no other choice, it isn't really a prioritization).

The Scoring Rules are described herein.

Scoring Rule 1: The category of the first event to get picked out of the list of m events that take place in the move gets (m−1) points, the second gets (m−2) and so on. The category of the last event to get picked gets 0. In addition, the act of picking is a relative one, so when an event is picked, all the other available yet-unpicked choices at the time get −1.

Scoring Rule 2: The sum of points distributed every move is zero, except in the following cases. (a) An event is ignored (either explicitly ignored by selecting an ‘ignore’ option or stating it somehow, or just not selected during that move), despite the availability of actions/options that remain unused. In this case, the category of the ignored event gets −1. This is an act of active and deliberate deprioritization. (b) An event is ignored (either explicitly ignored or just not selected during that move), and instead, an event from a previous move is picked. In this case, the ignored event category gets −0.5 and the previous move event gets+0.5. (here, the sum total of points distributed in that specific move is negative, but the sum total across the entire game is still zero). (c) An event is ignored (either explicitly ignored or just not selected during that move), and instead, a proactive action is taken. A proactive action is one that is not provided as an option within the simulation but is something the user does proactively. In this case, the ignored event category gets −0.5 and the category associated with the proactive action gets 0.5. Currently, one may choose a proactive action among several available in a library. If one chooses to construct a response (e.g. type in or say) proactively, then natural language processing will be used to categorize that response into a pre-existing category, and then a score will be assigned to that category. (d) When a previous move event is responded to, or proactive action taken while there are yet-unpicked events in the current move, all the available unpicked events' categories at the time this happens get a −0.5. If some of them get picked later in the same move, they will get points as per Rule 1 above.

To calculate the cumulative prioritization score for each category, at the end, for each category, the points across all events and moves are summed up, including partial scores for “previous move” and “proactive” actions. The ‘maximum’ score that the player could have achieved in each category is calculated—if all its events had been completely prioritized over all other categories at every move, per the scoring rules above. The ‘minimum’ score that the player could have achieved in each category is calculated—if all its events had been completely deprioritized over all other categories at every move, per the scoring rules above. The final score's distance to the maximum score is the final prioritization score, calculated as a proportion or percentage.

Within the gamified simulation, it is possible to communicate with both virtual and real persons, in synchronous and asynchronous ways. These communications may be traced to reveal patterns in terms of three key areas: collaboration, advice-seeking behaviors, and influence on others.

A sampling of the kinds of ‘paradata’ (clickstream, data about data) that may be used for these communication indices and the kinds of indices that may be calculated include the following:

1. Collaboration
a. Degree to which help was sought and given
   i. With respect to ‘real’ others (e.g. in multiplayer mode) and also to ‘virtual’ others (e.g. from machine-generated virtual advisors)
   ii. With respect to contacting coaches (e.g. asynchronously or offline)
   iii. Collaboration under stress (e.g. under ‘red alert’ conditions)

2. Advice Seeking
a. Advice seeking formulas to determine the influence of experts, role power etc.
b. Consensus seeking
   i. Extent to which consensus was reviewed, used as is, or considered in further action
c. Reliance on advice versus exploring own options
d. Usage of advice under stress (e.g. when the simulation is in a ‘red alert’ state)

3. Influence
a. Extent to which the user's recommendations were heeded by others
b. Social/organizational network analyses to reveal about the person's influence in terms of centrality, reciprocity, clustering, social networking potential etc.

Described herein is the analytics for Constructed Response Data. Within the delivery method described earlier, in addition to selecting responses from a library of possibilities, users may also construct responses by typing in text using a chatbot interface or something similar, or in the future, speaking in their responses which would be thus be recorded in audio, video or text formats. These constructed responses would be matched with the most appropriate option in the library, which, in turn, would be used to decide the change in data values in the next iteration of the simulation. If an exact match isn't found at first, the system would engage the user in conversation (using Chatbot technologies such as linguistic/rule-based, machine learning/AI, or hybrid models using linguistic and machine learning techniques), and ask a series of questions to determine the best option among those available.

Also, there are other points of interaction with the system which allow for or even require (based on admin configuration) constructed responses. For instance, users may be asked for their rationale for choosing specific actions, or users' interactions with coaches, other users (especially in group mode) or notes to themselves can all be recorded. Such data, which take the form of text—even if in audio or video form—provides rich potential for analytics. Text analytics using Natural Language Processing (NLP), Natural Language Understanding (NLU) or other derived analytics methods will be used to identify themes, sentiments, code responses into pre-identified or newly created categories or otherwise make sense of these data.

Described herein is the method of measuring Individual and Group Developmental Trajectories. All the indices presented in the previous paragraphs were described at the individual level of analysis—such as the user's competency profile, the user's prioritization/choices, and the user's communication patterns. Each of these may be conceivably aggregated to the group level, and also tracked across time, to yield different levels of insights about change over time and across people. For instance, perhaps a trajectory of growth across people might show a sudden change in some people on some competencies, which may be the result of an intervention or learning event. Alternatively, lack of growth or consistency in scores of a user over time in some areas, such as a tendency to prioritize certain type of events to attend to, might reveal a dispositional attribute.

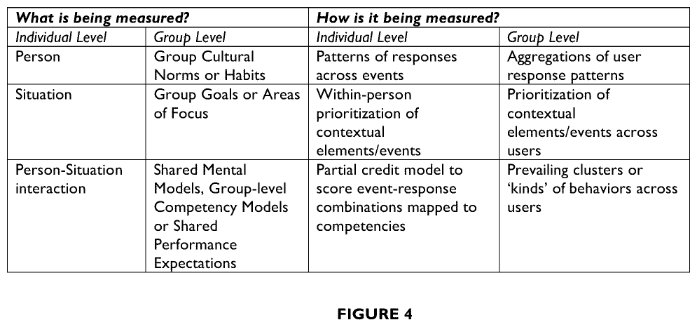

Referring to FIG. 4, the table illustrates mixed-methods measurement at the individual and group level. Described herein is the method of Natural Language Processing applied to a participant's response. In order to maximize the contextual realism experienced by a participant while taking decisions on Cymorg, the system does not directly provide the participant with options to choose from. Based on the state of the game, the system selects situations (“events”) by a process described in the original application to present in front of the participant. When the participant decides to respond to an event, the system merely asks them to describe in their own words what they think is the most important thing to do when faced with such an event. The system internally tries to match the participant's response with pre-scored action options, and asks the participant a series of questions about their intentions and rationale behind the response they have offered. From their responses to these questions, the system identifies the participant's choice of action, and scores the participant accordingly.

Described herein is the measure of Organizational Culture. Organizational Culture is a topic of great fascination because executives are interested in (a) knowing the corporate culture, (b) changing the corporate culture, and/or (c) leveraging the corporate culture to create competitive advantage. Measure and inform organizations about their organizational culture as an aggregation of their employees' behaviors over time and across situations, which then crystallize into a sense of ‘the way we do things here’—an accepted way to describe organizational culture. Until now, this has eluded organizational psychologists due to the lack of a measurement methodology that would allow such a ‘semi-idiographic’ method. Cymorg's measurement approach has made this possible, and what's more—can allow for commentary about organizational culture, when responses are aggregated across people, time and situations. Since language is the way we communicate our assumptions for the most part, it is imperative that we start examining language for reflections of organizational culture. This is exactly what the Cymorg chatbot experience allows for—by performing text analytics on the responses provided by users (i.e. constructed text responses using typed in or spoken responses), we are able to identify themes and clusters based on frequency and meaning of those text inputs. Specifically, by analyzing the semantic relationships between the text inputs of users and a set of ‘culture markers’ identified by Cymorg a priori, we are able to generate reports at the individual and group level, of how closely individuals (or groups) cluster around specific dimensions of ‘culture styles’.

For example, in the current conceptualization, we theorize two dimensions along which organizational cultures vary—one, interpersonal relationships and two, openness to change (these two dimensions were arrived at after thorough literature review of existing research on organizational cultures—but these are placeholders/incidental to the technique being described here. Any two or more dimensions may be used and their requisite word libraries provided for the text analytics being described). By applying text analytics to the user provided text inputs and matching them to these two dimensions, we are able to plot every individual user (and thus, the whole group/organization) at specific points in this two-dimensional space, representing their endorsement of specific culture styles, by way of frequency (number of times/number of words) and intensity (closeness of match to target words).

The following processing is performed with the free text responses we get from Cymorg participants. (1) Identify themes and clusters that arise from an individual's behavior—based on frequency and meaning of those text inputs (what we call ‘Bottom Up Analytics’). (2) Make it possible for analysts to search for certain reference words: markers or themes that are important for the group under consideration (for instance, ‘loyalty’, or ‘transparency’ or ‘collaboration’) The system will go through all the simulations, and produce a short list of participants whose games involve the use of words and phrases that are semantically similar (‘tightly clustered’) with the reference words—we call this ‘Top Down Analytics’. (3) Theorize two dimensions along which organizational cultures vary—one, interpersonal relationships and two, openness to change (these two dimensions were arrived at after thorough literature review of existing research on organizational cultures—but these are placeholders/incidental to the technique being described here. Any two or more dimensions may be used and their requisite word libraries provided for the text analytics being described). By applying text analytics to the user provided text inputs and matching them to these two dimensions, we are able to plot every individual user (and thus, the whole group/organization) at specific points in this two-dimensional space, representing their endorsement of specific culture styles, by way of frequency (number of times/number of words) and intensity (closeness of match to target words).

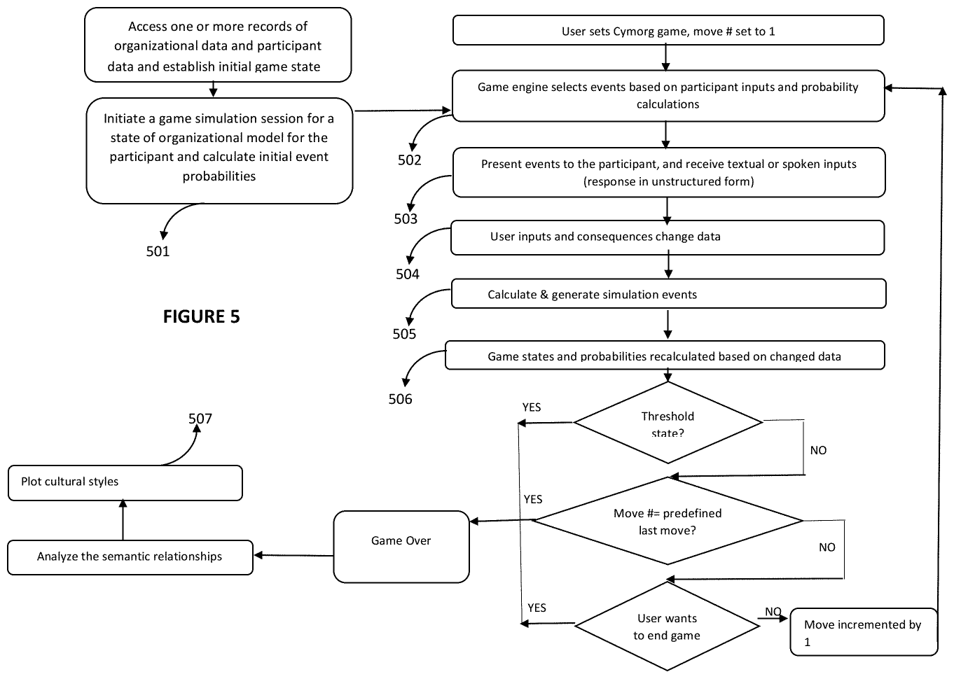

Referring to FIG. 5, it depicts the game utilizing semantic analysis. Described herein are the steps for accepting User Input as Free Text. A Cymorg simulation consists of a set of background data elements, and a curated set of situations that are realistic and relevant for the job role and learning objectives of the individuals being trained. These situations have been authored into the tool ahead of the simulation run, along with several possible response options, each of which is scored for one or more job-related competencies. Each option is also associated with certain identifying labels or tags, which typically describe the motivations that a user may have for choosing that option. When a participant accesses the simulation, the Cymorg core engine picks the most appropriate situation or situations out of this list of situations, based on their probability of occurrence 501, which in turn depends on the value of one or more of the data elements (explained earlier in the existing application). When a situation is chosen from the list, it is shown to the participant on the screen. The participant is invited to respond to the situation by clicking on the ‘Respond’ button. A computer implemented method determines the cultural style of a participant of an organization by accessing records of organizational data and participant data to generate an instance of simulation 501, and initiating a game simulation session. The method receives inputs from the participant to automatically calculate and generate a first set of simulation events 502, and presents to the participant a first set of events, and receives a response as textual or spoken inputs in an unstructured form 503. It further performs text analytics on the inputs, identifies themes and clusters based on frequency and meaning of inputs, and calculates probabilities and generates a further set of simulation events for a changed state of organizational model 504. It also presents a further set of simulation events 505 to the participant for inputs. The method steps are iterated, probabilities are recalculated 506 and the game terminates when a state marker is reached. The semantic relationships are analyzed and reports generated on culture styles 507.

On clicking on the Respond button, a chatbot window opens up. The participant is asked to describe the most important action that they feel they need to take at this point, and an input box is provided. When the participant types in the response and hits ‘enter’, his/her entry is compared with the pre-scored set of options, and each option is given a score between 0 and 100, based on how good the match is, or how confident the algorithm is, that the option comes close to capturing the same meaning as the user input. Options that have scored less than 50% of the score of the highest scoring option are eliminated from contention as being unlikely candidates. In order to arrive at the option that is the closest match with the participant's motives and intentions, the tags associated with the remaining options are then presented to the user, with a request to pick the one that comes closest to his/her motivation for suggesting the course of action. Based on participant choice, the options are narrowed down to an even smaller subset of the original set of options, and these are offered to the participant finally, for his/her confirmation of the exact choice of action desired. The participant is also given the option of deciding not to pick on the pre-built choices, but to proceed with the original free text response provided. The participant is scored against his/her job competencies based on the final choice of decision, but we use his/her initial free text response for the cultural analytics.

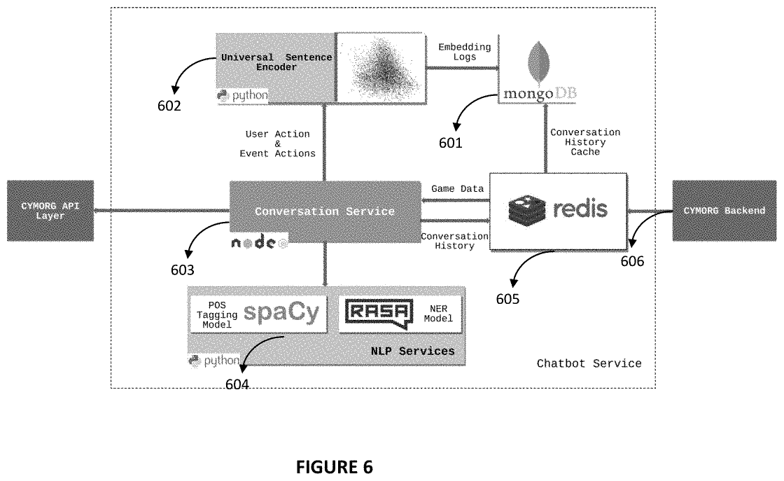

Referring to FIG. 6, an exemplary architecture is described. The Chatbot feature allows the user to come down to a single action via means of an AI backed Conversational UI. The service runs on top of the corresponding Cymorg Tenant Redis 605, for fetching the game related data and uses Universal Sentence Encoder 602 for embedding the user entered action and the event actions available and performs a Cosine Similarity for matching them. Further the conversation also uses the associated Action Tags for refinement. The service also includes a Spacy—POS [Part of Speech] Tagging Model 604 for differentiating between sentences starting with Nouns/Verbs and a RASA NLU Model for Intent Identification [NER—Named Entity Recognition] on the user message. The conversation context, history and the embedding filtered results are stored in a database, for example, the Mongo DB instance 601.

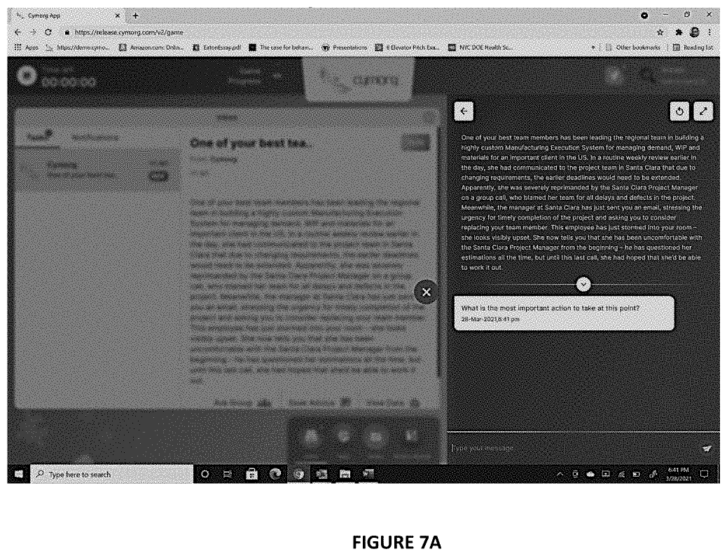

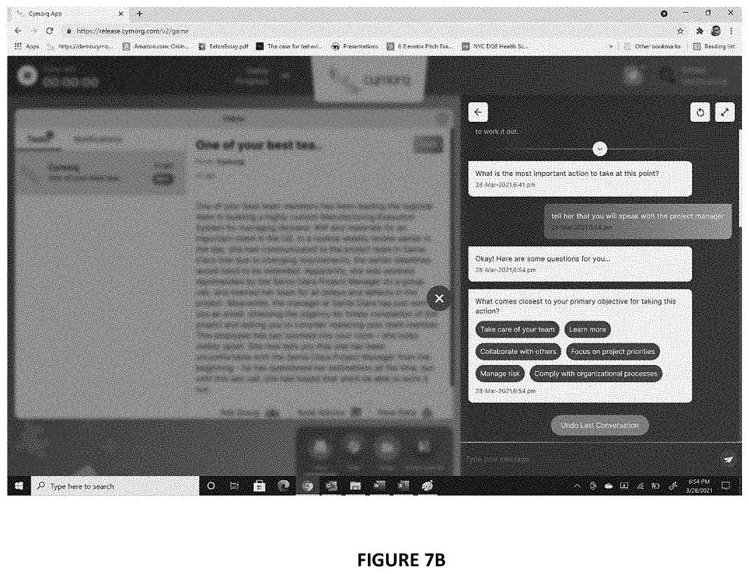

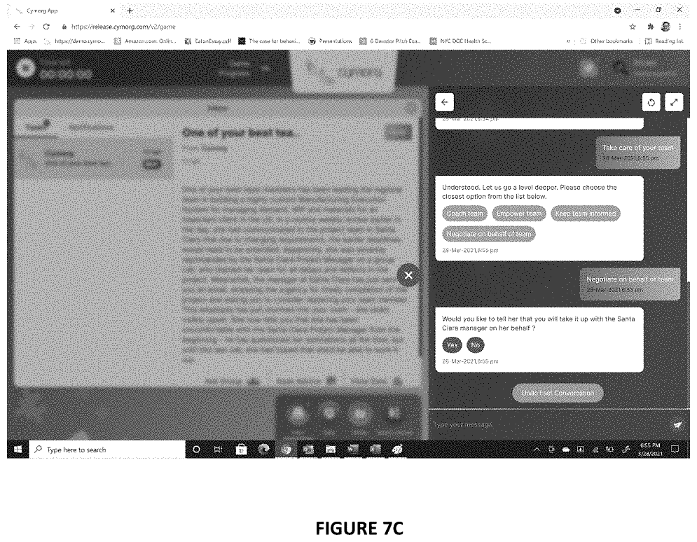

FIGS. 7A-7C exemplarily illustrate how free text input is collected from participants and Conversational AI services is used to match the response to the appropriate pre-authored choice. The Bottom Up Analytics and Top-Down Analytics are described herein. As soon as a participant completes a gamified simulation, the entire data pertaining to his activity on the platform—all the text entered, the buttons clicked on, the time taken at each step, the choices made—is accessed by the Cymorg reporting engine. The bottom-up analytics is presented in the game reports that are automatically generated after every game. It can also be aggregated over all the games played by an individual and visualized in the form of a word cluster bubble, that depicts the words and themes frequently used by the participant. The text is first stripped of everything except verbs, and these are semantically grouped into clusters, and their frequency is also noted. The size of a cluster is the sum of the frequency of all the words that are close to one another. A visual depiction of the clusters for each game (or across games, for an individual player) is shown in the game report of the individual participant. This may easily be visually compared with the clusters across the entire population of participants to depict different patterns of thinking about the same situations and how to deal with them. For the top-down analysis, an advanced query builder functionality has been provided for users with admin privileges. Using the query builder, the user can construct a query, where among other conditions (such as time taken for planning, the value of certain competencies, the number of proactive actions taken, etc.) the user can type in a reference word, and request to see all participants in a given population whose responses during the simulation showed a semantic closeness to the reference word. The reference word is checked against the clusters created from the bottom-up analysis of each game. The game is ‘selected’ by the query if the word itself was used in by that participant in that game, either frequently by itself, or in combination with other words of very similar meaning. It is not selected otherwise (the minimum frequency to qualify for a cluster, as well as a measure of the closeness in meaning between two words in a cluster are parameterized). Thus, the admin user can confirm the number of participants who use words in their responses that are aligned to themes that are significant and important for the organization, e.g., the value system of the organization.

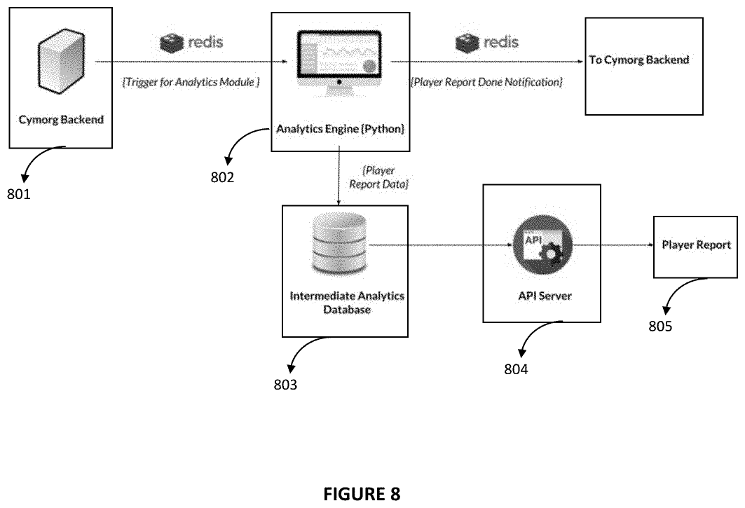

FIG. 8 illustrates the analytics module. The system architecture is described herein. The Text Analytics services handles the clustering use cases within the Cymorg application for individual game reports, player reports and for the Query Builder—word clustering based search. The service has been implemented, for example, with Python3.7 and can be accessed via REST APIs implemented in FlaskRestPlus and run via Gunicorn.

As the player plays the game, data corresponding to the same are updated in the Cymorg database layer. Upon completion of the game (Successful or otherwise), a message is relayed from the Cymorg backend 801 to the analytics engine through the Redis message queue service which triggers the analytics and report generation mechanism. The data is extracted from the AWS DB using queries and the analytics and calculations are done using Python 802. The processed/analyzed data is then stored in an intermediate database 803 from where it'll be obtained using Python-Django Rest API's 804. After the processing and report 805 generation is complete, a notification is sent back indicating the same via the Redis message queue. This will make the report available to the end user for viewing, downloading etc.

Along with the clustering-based processing, the word counts are also important. If any of the words are occurring more than a predefined number of times, then that word is said to form a cluster of its own. In the case of the Top-Down approach this is modified so that a count-based cluster is said to occur if any of the search words is available in the text corpus more than once. Exemplarily, use DBSCAN clustering algorithm. This requires two parameters for its functioning and also the algorithm can be fine-tuned using these. The two parameters are (a) max_distance/epsilon: This corresponds to the max distance within which the words can occur for them to be classified into a group. (b) min samples: The min number of words which should be available so that these can be considered as a group to form a cluster. This value is also used as the predefined count of words as mentioned above for finding the count-based clusters. Both these values are parameterized and can be fine-tuned by an administrator.

Along with the two above mentioned parameters, a parameter called ‘eps_range’ is also received in the request. This is used to increment the value of epsilon if no clusters are formed with the initial value of epsilon. Using this parameter, the algorithm performs as mentioned below: The clustering is performed with the default values of epsilon and min samples provided. If no clusters are formed, then the value of epsilon is incremented in a range till the eps range value. E.g., if the epsilon was 5 and eps range was 2, then the epsilon value will be incremented to 6 and clustered and if still no clusters are formed, will be incremented to 7 and clustered again. If still no clusters are formed, then clustering is said to have failed. A value cluster density within the result of clustering indicated at what iteration the cluster was formed. In the “Top-Down Approach:”, the process occurs same as above but after each clustering instead of checking if any cluster was formed, the check will be whether any cluster was formed with the given search word in it. If the condition fails, then the epsilon is incremented and re-clustered.

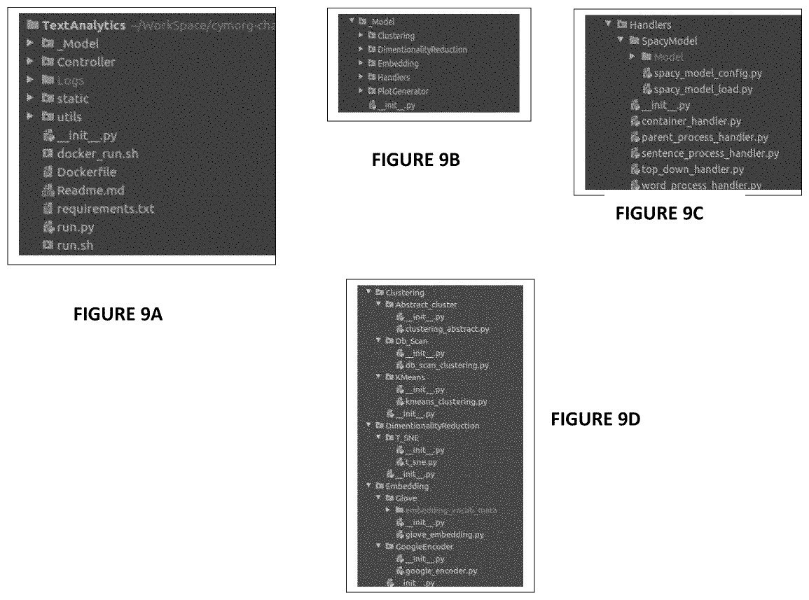

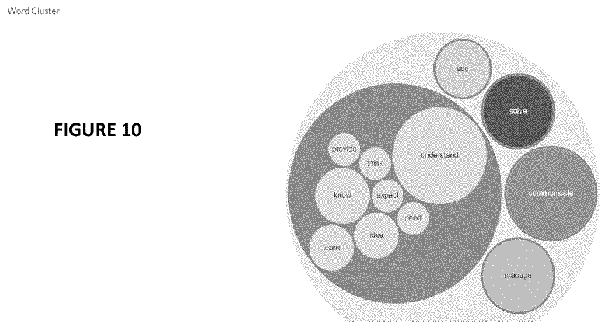

Referring to FIGS. 9A-9C, the structure of the service is illustrated. The Controller includes all the API endpoint handlers along with the validators used for the incoming requests. The utils consists of the utility functions along with the configurations and the logger singleton implementation. The configurations are application specific and are not fetched from the Configurations API. For the current implementation, these need not be changed. Only if any of the algorithms or models used for clustering/dimensionality reduction/Embedding needs to be changed, the change must be made in the configurations. Each of these perform one of the core processes used within the Text Analytics Service. The entry point to the entire processing is within the Handlers which consists of the sentence_handler to fetch the prominent VERBs and the base process handler to perform the processing on the entire data. Pandas has been used to manage all the data manipulation and the mappings between the data elements.

The container_handler takes care of all the Dependency Injection tasks within the application. Based on the configuration the kind of model to be used for each of the processes are also defined from within this. The word_process_handler and the sentence_process_handler performs the same operation with the latter one having the process to fetch the prominent VERBs. This is done via means of a SpaCy model. The entire loading and downloading of the SpaCy model are handled inside the SpacyModel folder. The top_down_handler is used to do the processing for the same as mentioned inside the Top-Down process. The parent_process_handler forms the main handler within the application. The entire data processing pipeline is implemented with Pandas within this and it is from here that all the other processes are called as required.

The other folders within _Model perform the tasks as required. Each of these has an abstract class implementation which allows for changing the model in future. The clustering has both KMEANS and DBSCAN implemented. Currently DBSCAN is the algorithm being used. Similarity inside Embedding, both Glove and GoogleEncoder is available. This can also be changed from within the Configuration, but since a word embedding is done, Glove will be providing a better performance since context is not required. The Glove 300 dimension model is being currently used, if the model needs to be changed then this too is possible from Configuration file. The GoogleEncoder being used here is from the Encoder Service and an API is used to communicate with the same. Hence the service should be up for using this feature.

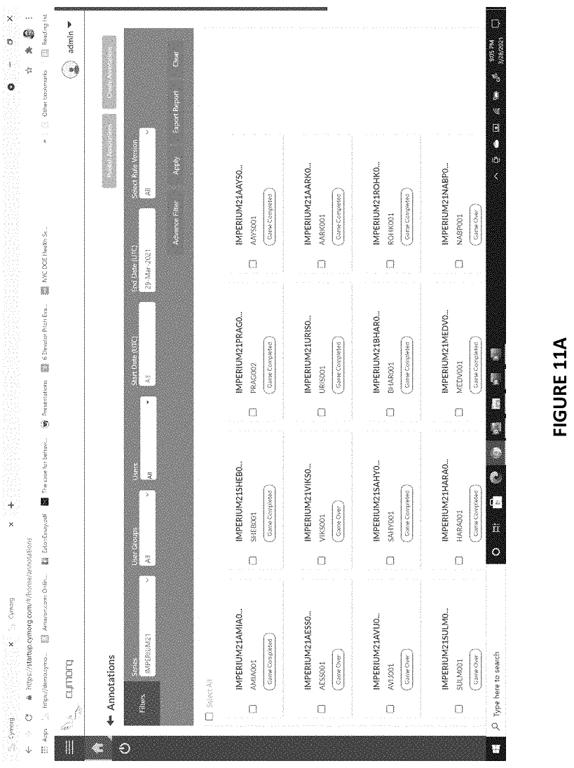

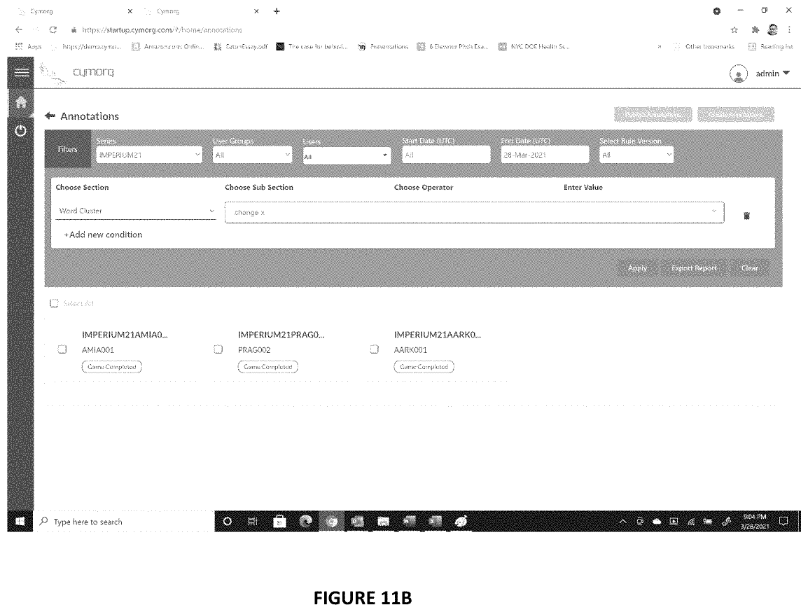

FIG. 10 illustrates a bottom up analytics generated as part of the automatic game report at the end of every simulation. FIG. 11A exemplarily depicts a list of all games played in a particular series while FIG. 11B exemplarily displays a series, filtered on games that feature sentiments semantically close to the word “change”.

Described herein are the process steps of Cultural Styles Analytics. The intent of the cultural styles metric is to plot every individual in a group of participating individuals on a 2×2 matrix that is defined by four quadrants: (a) The “Grow” quadrant—‘collaborative’ and ‘change-focused’ cultural style; (b) The ‘Nurture’ quadrant—‘collaborative’ and ‘stability-seeking’ cultural style; (c) The ‘Conserve’ quadrant—‘competitive’ and ‘stability-seeking’ style; and (d) The ‘Drive’ quadrant—‘competitive’ and ‘change-focused’ style.

The cultural styles analytics are generated after an entire group of individuals completes one or more games, drawing up plans, responding to situations, elaborating on them or explaining their rationale, and leaving notes for their coaches. All this text is selected from the game and taken to the reporting area. Then, the following steps are followed for the text belonging to each participant. As a first step, the “stop words” are eliminated from the text (stop words are common English words that do not add any meaning, like ‘the’ or ‘it’ or ‘and’, etc. Once all the stop words are eliminated, the rest of the words are represented as 50-dimensional vectors using the GloVe Vector (unsupervised training) algorithm. This step represents all the words in a logical 50-dimensional space where words that are close in meaning to one another along one or more dimensions are plotted in proximity to one another. We then determine how close the participant's words are, semantically, along two sets of “cultural dimensions” or axes. One axis consists of a spectrum of sentiment, ranging from ‘individuality’ or ‘competitive’ at one end, to ‘collaborative’ on the other. The other axis ranges from ‘change focused’ at one end to ‘stability-seeking’ at the other. We could start with a reference set of around forty words: ten words each that are synonymous with ‘competitive’, ‘collaborative’, ‘change-focused’ and ‘stability-seeking’. For each of the reference words, we find the Euclidean distance (which is a measure of the distance in meaning) between the words used by the participants and the reference word. We then sum up the total distances from the 10 ‘collaborative’ reference words and arrive at an average distance and calculate the average distance from the 10 ‘competitive’ reference words. By comparing the two figures, we get an understanding of where along the competitive-collaborative axis, the individual may fit—this defines the X-coordinate of the point on the graph. The same operation is performed with the ‘stability-seeking’ and ‘change-friendly’ reference words, and we arrive at an understanding of where the individual might fit along the Y-axis. The two coordinates jointly determine where the individual will fit on the cultural styles 2×2 matrix. When all the individuals of the group are thus plotted, generate a scatter plot that defines the dominant cultural style of the cohort or group. The Cultural Style generator has been written in Python.

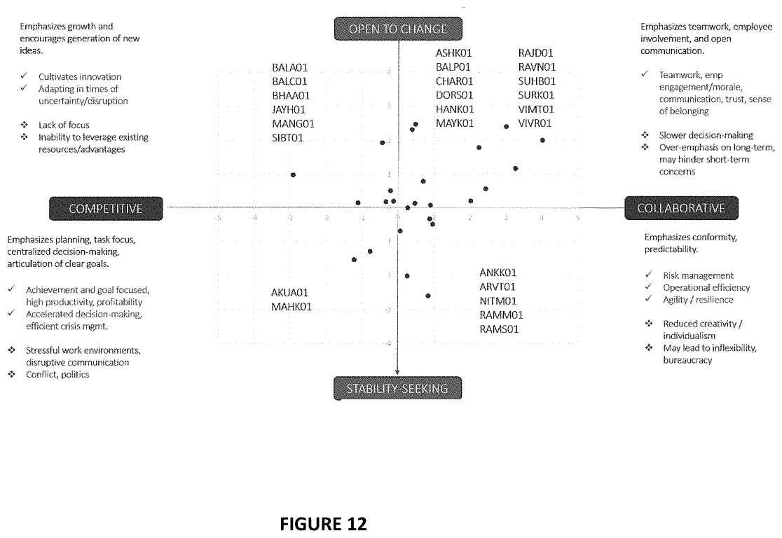

Referring to FIG. 12, a text based cultural style diagnosis for a group of mid-level managers in an R&D center of a semi-conductor manufacturing organization is illustrated.

While the inventive concepts described herein with reference to illustrative embodiments for particular applications, it should be understood that the inventive concepts are not limited thereto. Those having ordinary skill in the art and access to the teachings provided herein will recognize additional modifications, applications, embodiments and substitution of equivalents all fall within the scope of the inventive concepts. Accordingly, the inventive concepts are not to be considered as limited by the foregoing description.

What is claimed as new and desired to be protected by Letters Patent of the United States is:

1. A computer implemented method of determining the cultural style of a plurality of participants of an organization, comprising the steps of:
accessing one or more records of organizational data and said plurality of participants data to generate an instance of simulation;
initiating a game simulation session for a state of organizational model for said plurality of participants;
receiving input from said plurality of participants to automatically calculate and generate a first set of simulation events specific to said plurality of participants;
presenting to said plurality of participants said first set of events, and receiving a response as textual or spoken inputs in an unstructured form;
performing text analytics on said inputs, and identifying themes and clusters based on frequency and meaning of said inputs;
calculating probabilities of a simulated set of events for a changed state of organizational model resulting from said plurality of participants' responses to said set of events;
generating a further set of simulation events specific to said plurality of participants based on said changed state of organizational model, and presenting said further set of simulation events to said plurality of participants for inputs;
iterating said steps of performing text analytics, calculating probabilities and generating a further set of events, and receiving inputs from said plurality of participants;
terminating said iterations when a state marker is reached; and
analyzing the semantic relationships between said inputs of said plurality of participants and a set of culture markers identified priori, and generating reports on how closely said plurality of participants cluster around specific dimensions of culture styles.

2. The method of claim 1, wherein said cultural styles expose the decisional approach, critical assumptions and priorities of said plurality of participants.

3. The method of claim 1, wherein said step of analyzing said semantic relationships comprises plotting said plurality of participants' responses to a plurality of dimensions of culture at specific points in a multidimensional space, representing endorsement of specific culture styles by measurement of frequency and intensity of words used in said plurality of participants' responses.

4. The method of claim 1, wherein said first set events and said further set of events are presented after applying dynamic and contextual gamified simulations.

5. The method of claim 1, wherein said reports are generated at an individual or group level.

6. The method of claim 1, further comprising the steps of: matching said plurality of participants' responses with pre-scored action options; questioning said plurality of participants about intentions and rationale behind said responses offered; identifying said plurality of participants' choice of action from said responses to said questions; and scoring said plurality of participants.

7. The method of claim 6, wherein said plurality of participants with scores that are less than a predetermined percentage of score of the highest scoring option are eliminated s unlikely candidates.

8. The method of claim 1, after said plurality of participants complete a gamified simulation, entire data of text entered, buttons clicked on, time taken at each step, and choices made pertaining said plurality of participants' responses, is recorded for analysis.

9. The method of claim 1, wherein verbs from said responses of said plurality of participants are semantically grouped into clusters, and their frequency is measured, wherein the size of a cluster is the sum of the frequency of all the words that are close to one another.

10. The method of claim 1, wherein a visual depiction of the clusters for each game, or across games, for one of said plurality of participants is depicted in the game report of the respective said one of plurality of participants, and said depiction is visually compared with the clusters across the entire population of participants to depict different patterns of thinking.

11. The method of claim 1, wherein a user with administrative privileges can type in a reference word, and request to see said plurality of participants in a given population whose responses during the simulation who showed a semantic closeness to said reference word, whereby said user can confirm the number of participants who use words in their responses that are aligned to themes.

12. The method of claim 1, wherein if said plurality of participants is a new recruit, said simulation comprises a set of background data elements, and a curated set of situations that are realistic and relevant for the job role and learning objectives of said plurality of participants being trained.

13. The method of claim 3, wherein said step of generating said plot on a multidimensional cultural style matrix, further comprising the steps of:
defining four quadrants of cultural style;
generating cultural style analytics after an entire group of individuals completes one or more responses to said generated events;
determining how semantically close said plurality of participant's words are, along two sets of cultural dimensions or axes, further comprising the steps of:
identifying a reference set of words;
determining the Euclidean distance between the words used by said plurality of participants and the reference word;
determining the average distance from said reference words, and defining the coordinate points on the graph along all the axes; and
thereby, generating a scatter plot that defines the dominant cultural style of the group of said plurality of participants.

14. A computerized system for determining the cultural style of a plurality of participants of an organization comprising the following elements:
one or more units for input and output communications between a user, game databases and a core engine;
said game databases, further comprising databases of user profiles, definitions and values of the parameters for computing states of the game, possible events, possible actions by said plurality of participants in response to possible events at the different states of the game, and the rules of the game;
analytical databases that stores information about completed simulations;
said core engine comprising one or more processors for:
accessing one or more records of organizational data and participant data to generate an instance of simulation;
initiating a game simulation session for a state of organizational model for said participant;
receiving input from said plurality of participants to automatically calculate and generate a first set of simulation events specific to said plurality of participants;
presenting to said plurality of participants said first set of events, and receiving a response as textual or spoken inputs in an unstructured form;
performing text analytics on said inputs, and identifying themes and clusters based on frequency and meaning of inputs;
calculating probabilities of a simulated set of events for a changed state of organizational model resulting from said plurality of participants' response to said set of events;
generating a further set of simulation events specific to said plurality of participants based on a changed state of organizational model, and presenting said further set of simulation events to said plurality of participants for inputs;
iterating said steps of performing text analytics, calculating probabilities and generating a further set of events, and receiving inputs from the user;
terminating said iterations when a state marker is reached; and
analyzing the semantic relationships between the inputs of said plurality of participants and a set of culture markers identified priori, and generating reports on how closely plurality of participants cluster around specific dimensions of culture styles.

15. The system of claim 14, wherein said stored information further comprises targets achieved and missed, decisions taken, advice sought, data items clicked on, and choices made by said plurality of participants.
